(19) United States
(12) Patent Application Publication
(10) Pub. No.: US 2021/0066939 A1
(43) Pub. Date: Mar. 4, 2021

(54) Rechargeable Power Supply Assembly

(71) Applicant: Judy Fichter, Clarksville, TN (US)

(72) Inventor: Judy Fichter, Clarksville, TN (US)

(21) Appl. No.: 16/552,685

(22) Filed: Aug. 27, 2019

(51) Int. Cl. H02J 7/00; H01R 33/76; H01R 31/06

(52) U.S. Cl. CPC H02J 7/0065; H02J 7/0045; H01R 31/065; H01R 33/7664; H02J 7/0047

(57) ABSTRACT

A rechargeable power supply assembly for supplying AC voltage in a remote location includes a housing that can slidably engage a power tool battery for retaining the housing on the power tool battery. A plurality of contacts is each coupled to and extends away from the housing. Each of the contacts is positioned at strategic locations corresponding to terminals on the power tool battery. A plurality of female electrical outlets is each recessed into the housing. Each of the female electrical outlets receives electrical current from the power tool battery supply voltage to an electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to power supply devices and more particularly pertains to a new power supply device for supplying AC voltage in a remote location.

### BRIEF SUMMARY OF THE INVENTION

An embodiment of the disclosure meets the needs presented above by generally comprising a housing that can slidably engage a power tool battery for retaining the housing on the power tool battery. A plurality of contacts is each coupled to and extends away from the housing. Each of the contacts is positioned at strategic locations corresponding to terminals on the power tool battery. A plurality of female electrical outlets is each recessed into the housing. Each of the female electrical outlets receives electrical current from the power tool battery supply voltage to an electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a rechargeable power supply assembly according to an embodiment of the disclosure.

FIG. 2 is a bottom perspective view of an embodiment of the disclosure.

FIG. 3 is a top phantom view of an embodiment of the disclosure.

FIG. 4 is a right side phantom view of an embodiment of the disclosure.

FIG. 5 is an exploded in-use view of an embodiment of the disclosure.

FIG. 6 is a perspective in-use view of an embodiment of the disclosure.

FIG. 7 is a schematic view of an embodiment of the disclosure.

### DETAILED DESCRIPTION OF THE INVENTION

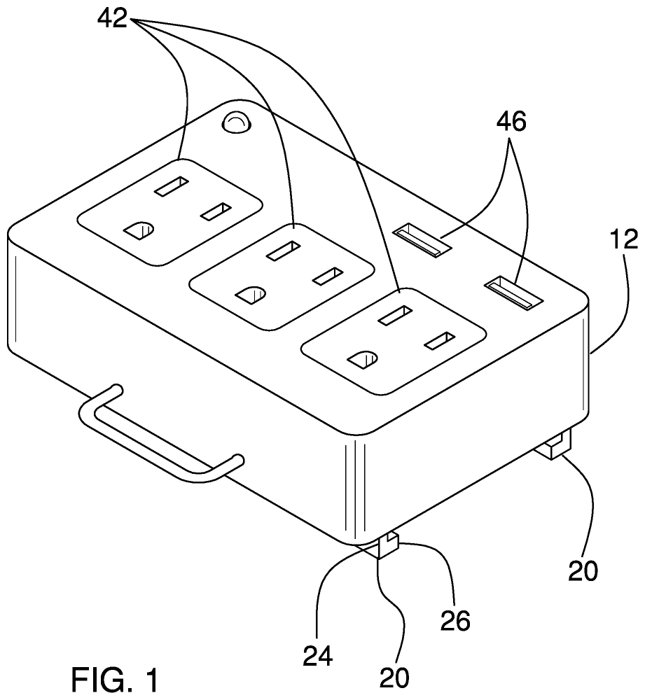

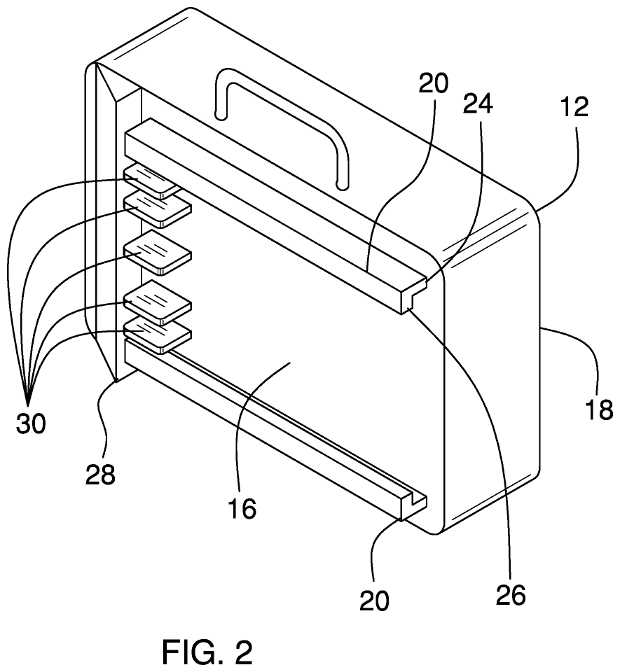

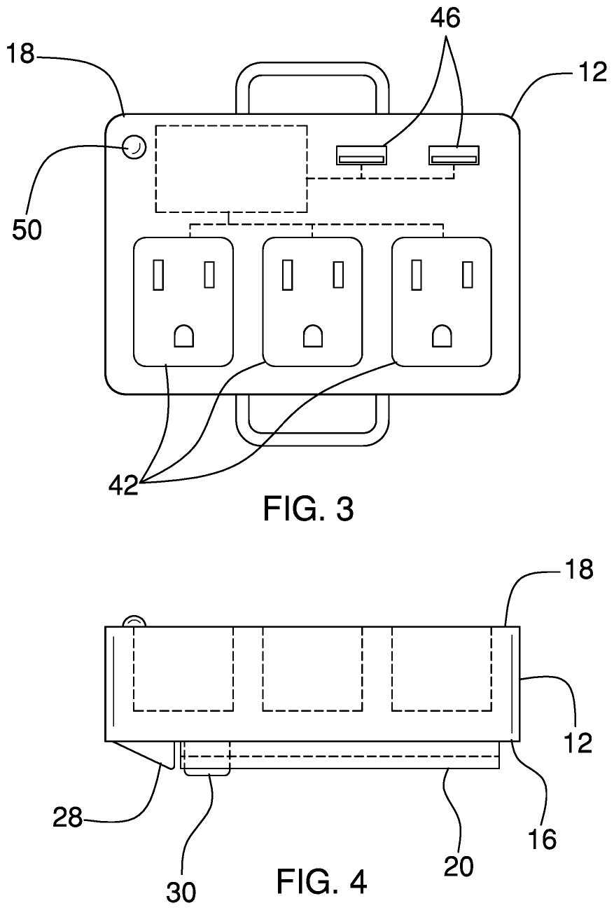

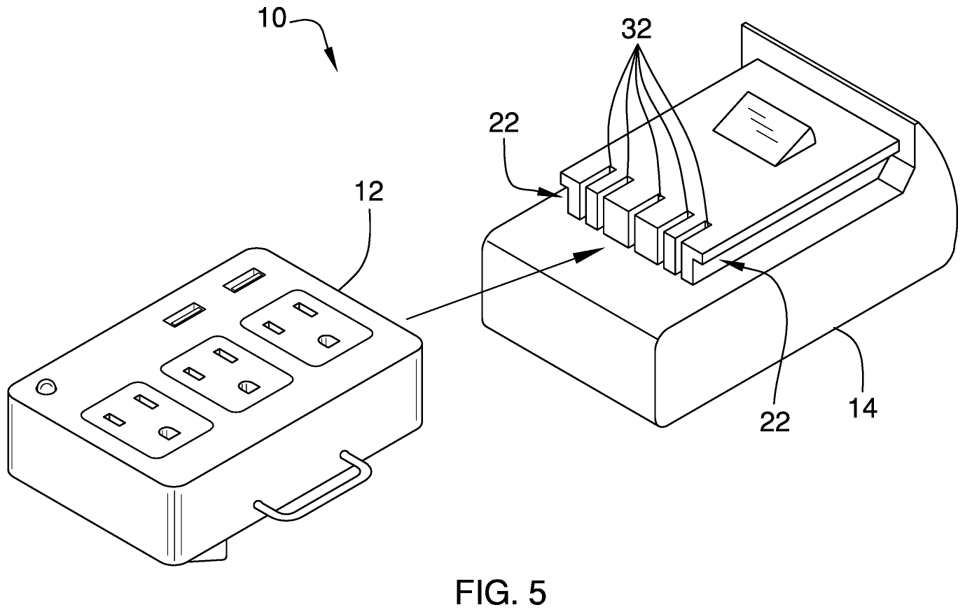

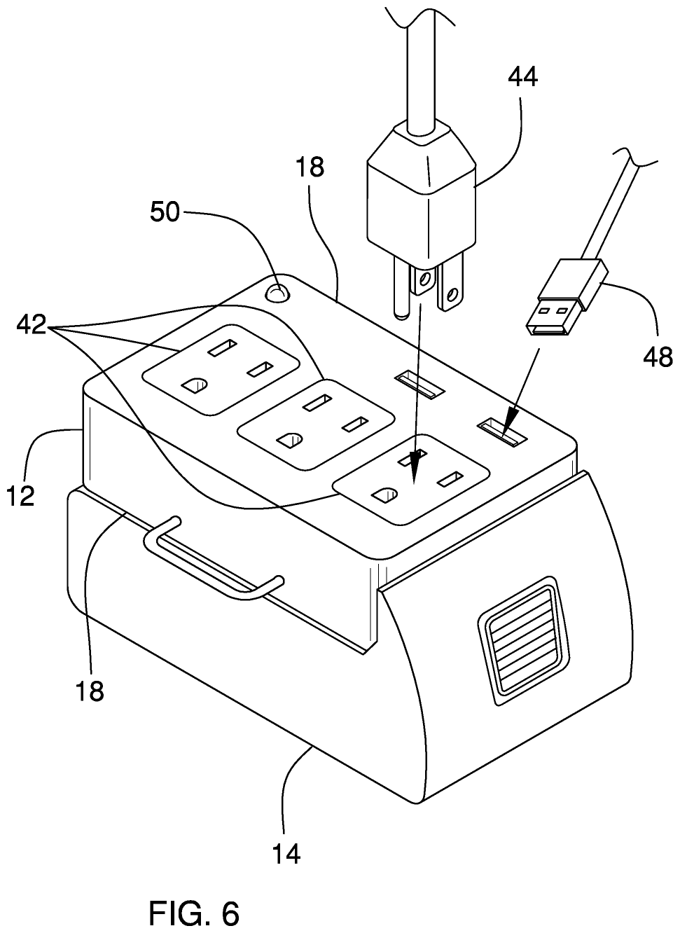

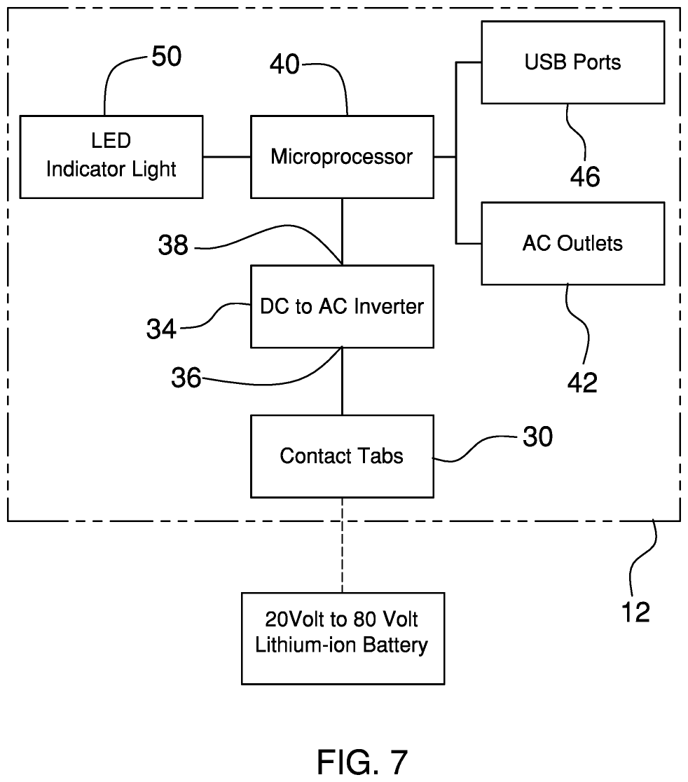

With reference now to the drawings, and in particular to FIGS. 1 through 7 thereof, a new power supply device embodying the principles and concepts of an embodiment of the disclosure and generally designated by the reference numeral 10 will be described.

As best illustrated in FIGS. 1 through 7, the rechargeable power supply assembly 10 generally comprises a housing 12 that can slidably engage a power tool battery 14 for retaining the housing 12 on the power tool battery 14. The power tool battery 14 may be a rechargeable lithium ion battery commonly associated with cordless drills or other cordless power tools. Additionally, the power tool battery 14 may have an operational voltage ranging between 12.0 VDC and 80.0 VDC.

The housing 12 has a bottom wall 16 and a top wall 18, and a pair of rails 20 is each coupled to the bottom wall 16 of the housing 12. The rails 20 are spaced apart from each other and each of the rails 20 slidably engages a respective channel 22 in the power tool battery 14. Each of the rails 20 has a leg 24 and a foot 26. The leg 24 of each of the rails 20 extends away from the bottom wall 16 having the foot 26 on each of the rails 20 being directed toward each other. A stop 28 is coupled to the bottom wall 16 of the housing 12 and the stop 28 is oriented perpendicular to the rails 20. The stop 28 abuts the power tool battery 14 when the rails 20 slidably engage the respective channel 22 for inhibiting the housing 12 from sliding off of the power tool battery 14.

A plurality of contacts 30 is provided and each of the contacts 30 is coupled to and extends away from the bottom wall 16 of the housing 12. Each of the contacts 30 is positioned between the rails 20. Moreover, each of the contacts 30 is positioned at strategic locations corresponding to terminals 32 on the power tool battery 14. In this way each of the contacts 30 engages a respective one of the terminals 32 when the housing 12 is slid onto the power tool battery 14. Moreover, each of the contacts 30 is comprised of an electrically conductive material such that each of the contacts 30 is in electrical communication with the terminals 32 when the housing 12 is slid onto the power tool battery 14.

An inverter circuit 34 is positioned within the housing 12, and the inverter circuit 34 has an input 36 and an output 38. The input 36 is electrically coupled to the contacts 30 to convert DC voltage from the power tool battery 14 into AC voltage. A control circuit 40 is positioned within the housing 12 and the control circuit 40 is electrically coupled to the output 38 of the inverter circuit 34. The inverter circuit 34 may be a miniaturized, solid state inverter or the like.

A plurality of female electrical outlets 42 is each recessed into the housing 12. Each of the female electrical outlets 42 is in electrical communication with the contacts 30. Additionally, each of the female electrical outlets 42 receives electrical current from the power tool battery 14. In this way each of the female electrical outlets 42 can supply voltage to an electronic device 44. Moreover, each of the female electrical outlets 42 is electrically coupled to the control circuit 40 for delivering AC voltage. Each of the female electrical outlets 42 is positioned on the top wall 18 of the housing 12.

A plurality of power ports 46 is provided and each of the power ports 46 is recessed into the housing 12. Each of the power ports 46 is in electrical communication with the contacts 30. Thus, each of the power ports 46 receives electrical current from the power tool battery 14 for supplying voltage to a portable electronic device 48. Each of the power ports 46 is electrically coupled to the control circuit 40 and each of the power ports 46 is positioned on the top wall 18 of the housing 12. Each of the power ports 46 may comprise a usb port, a micro usb port or any other type of charge port.

A light emitter 50 is coupled to the housing 12 to emit light outwardly therefrom. The light emitter 50 is electrically coupled to the control circuit 40. Additionally, the light emitter 50 is turned on when the contacts 30 engage the terminals 32 on the power tool battery 14. In this way the light emitter 50 notifies a user that the female electrical outlets 42 and the power ports 46 are active. The light emitter 50 may comprise an LED or the like and the light emitter 50 may emit green colored light.

In use, the housing 12 is slid onto the power tool battery 14 thereby facilitating the contacts 30 to engage the terminals 32. Thus, the inverter circuit 34 converts the DC voltage of the power tool battery 14 into AC voltage. In this way each of the female outlets 42 can supply AC voltage to an electronic device 44, such as Christmas lights or the like. Moreover, the female electrical outlets 42 can supply AC voltage at a location where electrical service is not available. Additionally, each of the power ports 46 can be employed for charging portable electronic devices 48 such as smart phones or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rechargeable power supply assembly being configured to employ a lithium ion battery for supplying alternating current electricity, said assembly comprising:
a housing that can slidably engage a power tool battery for retaining said housing on the power tool battery;
a plurality of contacts, each of said contacts being coupled to and extending away from said housing, each of said contacts being positioned at strategic locations corresponding to terminals on the power tool battery, each of said contacts being comprised of an electrically conductive material such that each of said contacts is in electrical communication with said terminals when said housing is slid onto the power tool battery;
a plurality of female electrical outlets, each of said female electrical outlets being recessed into said housing, each of said female electrical outlets being in electrical communication with said contacts, each of said female electrical outlets receiving electrical current from the power tool battery wherein each of said female electrical outlets is configured to supply voltage to an electronic device; and
a plurality of power ports, each of said power ports being recessed into said housing, each of said power ports being in electrical communication with said contacts, each of said power ports receiving electrical current from the power tool battery wherein each of said power ports is configured to supply voltage to an electronic device.

2. The assembly according to claim 1, wherein:
said housing has a bottom wall and a top wall; and
said assembly includes a pair of rails, each of said rails being coupled to said bottom wall of said housing, said rails being spaced apart from each other, each of said rails slidably engaging a respective channel in the power tool battery, each of said rails having a leg and a foot, said leg of each of said rails extending away from said bottom wall, said foot on each of said rails being directed toward each other.

3. The assembly according to claim 2, further comprising a stop being coupled to said bottom wall of said housing, said stop being oriented perpendicular to said rails, said stop abutting the power tool battery when said rails slidably engage the respective channel for inhibiting said housing from sliding off of the power tool battery.

4. The assembly according to claim 1, further comprising an inverter circuit being positioned within said housing, said inverter circuit having an input and an output, said input being electrically coupled to said contacts wherein said inverter is configured to convert DC voltage from the power tool battery into AC voltage.

5. The assembly according to claim 4, further comprising a control circuit being positioned within said housing, said control circuit being electrically coupled to said output of said inverter.

6. The assembly according to claim 5, wherein each of said female electrical outlets is electrically coupled to said control circuit wherein each of said female electrical outlets is configured to deliver AC voltage, each of said female electrical outlets being positioned on a top wall of said housing.

7. The assembly according to claim 5, wherein each of said power ports is electrically coupled to said control circuit, each of said power ports being positioned on a top wall of said housing.

8. The assembly according to claim 5, further comprising a light emitter being coupled to said housing wherein said light emitter is configured to emit light outwardly therefrom, said light emitter being electrically coupled to said control circuit, said light emitter being turned on when said contacts engage the terminals on the power tool battery wherein said light emitter is configured to notify a user that said female electrical outlets and said power ports are active.

9. A rechargeable power supply assembly being configured to employ a lithium ion battery for supplying alternating current electricity, said assembly comprising:
a housing that can slidably engage a power tool battery for retaining said housing on the power tool battery, said housing having a bottom wall and a top wall;
a pair of rails, each of said rails being coupled to said bottom wall of said housing, said rails being spaced apart from each other, each of said rails slidably engaging a respective channel in the power tool battery, each of said rails having a leg and a foot, said leg of each of said rails extending away from said bottom wall, said foot on each of said rails being directed toward each other;
a stop being coupled to said bottom wall of said housing, said stop being oriented perpendicular to said rails, said stop abutting the power tool battery when said rails slidably engage the respective channel for inhibiting said housing from sliding off of the power tool battery;
a plurality of contacts, each of said contacts being coupled to and extending away from said bottom wall of said housing, each of said contacts being positioned between said rails, each of said contacts being positioned at strategic locations corresponding to terminals on the power tool battery, each of said contacts being comprised of an electrically conductive material such that each of said contacts is in electrical communication with said terminals when said housing is slid onto the power tool battery;
an inverter circuit being positioned within said housing, said inverter circuit having an input and an output, said input being electrically coupled to said contacts wherein said inverter is configured to convert DC voltage from the power tool battery into AC voltage;
a control circuit being positioned within said housing, said control circuit being electrically coupled to said output of said inverter;
a plurality of female electrical outlets, each of said female electrical outlets being recessed into said housing, each of said female electrical outlets being in electrical communication with said contacts, each of said female electrical outlets receiving electrical current from the power tool battery wherein each of said female electrical outlets is configured to supply voltage to an electronic device, each of said female electrical outlets being electrically coupled to said control circuit wherein each of said female electrical outlets is configured to deliver AC voltage, each of said female electrical outlets being positioned on said top wall of said housing;
a plurality of power ports, each of said power ports being recessed into said housing, each of said power ports being in electrical communication with said contacts, each of said power ports receiving electrical current from the power tool battery wherein each of said power ports is configured to supply voltage to an electronic device, each of said power ports being electrically coupled to said control circuit, each of said power ports being positioned on said top wall of said housing; and
a light emitter being coupled to said housing wherein said light emitter is configured to emit light outwardly therefrom, said light emitter being electrically coupled to said control circuit, said light emitter being turned on when said contacts engage the terminals on the power tool battery wherein said light emitter is configured to notify a user that said female electrical outlets and said power ports are active.
